(19) United States
(12) Patent Application Publication
(10) Pub. No.: US 2023/0311704 A1
(43) Pub. Date: Oct. 5, 2023

(54) CONTROL DEVICE, MOVING OBJECT, METHOD, AND COMPUTER-READABLE STORAGE MEDIUM

(71) Applicant: HONDA MOTOR CO.,LTD., Tokyo (JP)

(72) Inventors: Akira SAITA, Tokyo (JP); Yuki ITO, Tokyo (JP)

(21) Appl. No.: 18/190,142

(22) Filed: Mar. 27, 2023

(30) Foreign Application Priority Data
Mar. 30, 2022 (JP) 2022-056542

(51) Int. Cl. B60L 58/16; B60L 58/14; B60L 3/12; B60L 3/00

(52) U.S. Cl. CPC B60L 58/16; B60L 58/14; B60L 3/12; B60L 3/0046

(57) ABSTRACT

A control device including a deterioration state acquisition unit for acquiring a deterioration state of a battery provided for a moving object, an upper limit value determining unit for determining, in accordance with the deterioration state, an upper limit value of a discharge power amount from the battery to an outside of the moving object within a predetermined period, and a discharge power amount limiting unit for limiting the discharge power amount from the battery to the outside of the moving object within the predetermined period to the upper limit value or lower.

The contents of the following Japanese patent application(s) are incorporated herein by reference:
NO. 2022-056542 filed in JP on Mar. 30, 2022.

### TECHNICAL FIELD

The present invention relates to a control device, a moving object, a method, and a computer-readable storage medium.

### BACKGROUND

In recent years, research and development related to secondary batteries contributing to energy efficiency have been carried out such that more people can secure access to sustainable and advanced energy that is reasonable and reliable.

Patent Documents 1 to 4 describe techniques related to charge and discharge of a secondary battery provided for a vehicle.

### Prior Art Document

Patent Document 1: Japanese Patent No. 6892895.

Patent Document 2: Japanese Patent No. 6596472.

Patent Document 3: Japanese Patent No. 6918877.

Patent Document 4: WO2013/014930.

### BRIEF DESCRIPTION OF THE DRAWINGS

FIG. 1 conceptually illustrates a usage form of a system 5 in an embodiment.

FIG. 2 illustrates an example of a system configuration of a control device 100.

FIG. 3 is a drawing for describing parameters used for a power transmission and reception control between an outside of a vehicle 10 and a battery 12.

FIG. 4 conceptually illustrates variations in a remaining usable power amount and a reference usable power amount.

FIG. 5 is a drawing for describing a control of a discharge power amount limiting unit 230.

FIG. 6 illustrates an example of dividing a range of A, which is usable for discharge to the outside, into three priorities.

FIG. 7 illustrates a priority in another battery 12.

FIG. 8 illustrates a priority that is set for the battery 12 of each vehicle 10.

FIG. 9 is a graph illustrating an example of a transition in deterioration states of the battery 12.

FIG. 10 illustrates an example of a transition in remaining usable power amounts.

FIG. 11 illustrates an example of a transition in assured power amounts.

FIG. 12 illustrates that, based on a present SOH, a correction value of the assured power amount or the remaining usable power amount is calculated.

FIG. 13 illustrates an operation content of the control device 100 when correcting the remaining usable power amount based on the present SOH.

FIG. 14 illustrates that, based on a SOH predictive value at the end of a period of use, the correction value of the assured power amount or the remaining usable power amount is calculated.

FIG. 15 illustrates the operation content of the control device 100 when correcting, based on the SOH at the end of the period of use, the remaining usable power amount.

FIG. 16 illustrates an example of a computer 2000.

### DESCRIPTION OF EXEMPLARY EMBODIMENTS

Hereinafter, embodiments of the present invention will be described, but the following embodiments do not limit the invention according to the claims. In addition, not all of the combinations of features described in the embodiments are essential for a solving means of the invention.

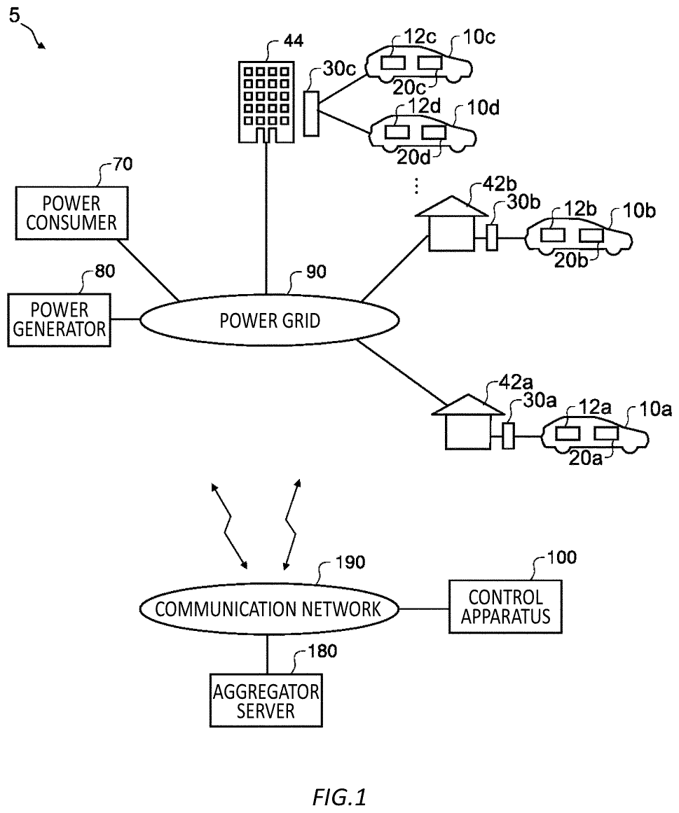

FIG. 1 conceptually illustrates a usage form of a system 5 in an embodiment. The system 5 includes a charge and discharge equipment 30a, a charge and discharge equipment 30b, a charge and discharge equipment 30c, a power generating device 80, a control device 100, an aggregator server 180, a vehicle 10a, a vehicle 10b, a vehicle 10c, and a vehicle 10d.

The vehicle 10a, the vehicle 10b, the vehicle 10c, and the vehicle 10d include a battery 12a, a battery 12b, a battery 12c, and a battery 12d, respectively. The vehicle 10a, the vehicle 10b, the vehicle 10c, and the vehicle 10d include a control device 20a, a control device 20b, a control device 20c, and a control device 20d, respectively. In the present embodiment, the vehicle 10a, the vehicle 10b, the vehicle 10c, and the vehicle 10d may be collectively referred to as the “vehicle 10”. The battery 12a, the battery 12b, the battery 12c, and the battery 12d may be collectively referred to as the “battery 12”. The control device 20a, the control device 20b, the control device 20c, and the control device 20d may be collectively referred to as the “control device 20”. The charge and discharge equipment 30a, the charge and discharge equipment 30b, and the charge and discharge equipment 30c may be collectively referred to as the “charge and discharge equipment 30”.

The control device 100 is connected to an aggregator server 180 through a communication network 190. The control device 100 can communicate with the charge and discharge equipment 30 through the communication network 190. The control device 100 controls the charge and discharge equipment 30 through the communication network 190. The control device 100 communicates with the control device 20 of the vehicle 10 through the communication network 190, and acquires various types of information of the vehicle 10 including a running history of the vehicle 10 and a SOC and a SOH of the battery 12.

The charge and discharge equipment 30, a power consumer 70, and the power generating device 80 are connected to a power grid 90. The power generating device 80 includes, for example, a power plant operated by a power company. Power generated with the power generating device 80 can be supplied to the charge and discharge equipment 30 and the power consumer 70 through the power grid 90. The power grid 90 is, for example, a power system.

Each charge and discharge equipment 30 performs charge and discharge of the battery 12 mounted on the vehicle 10 connected to each charge and discharge equipment 30. The vehicle 10 is, for example, an electric vehicle. The battery 12 is a battery for supplying power for running to the vehicle 10. The vehicle 10 may be an individually owned vehicle, a vehicle used in a business by a business operator, a shared car, or the like.

The charge and discharge equipment 30a is provided in a dwelling unit 42a, and it performs charge and discharge of the battery 12a of the vehicle 10a connected to the charge and discharge equipment 30a. If discharge of the battery 12a is performed, power provided from the battery 12a may be consumed by a power load within the dwelling unit 42a, or may be provided to the power grid 90 through a power line disposed in the dwelling unit 42a. The charge and discharge equipment 30b is provided in a dwelling unit 42b, and it performs charge and discharge of the battery 12b of the vehicle 10b connected to the charge and discharge equipment 30b. If discharge of the battery 12b is performed, power provided from the battery 12b is consumed by a power load within the dwelling unit 42b, or is provided to the power grid 90 through a power line disposed in the dwelling unit 42b. The charge and discharge equipment 30c is a charge and discharge equipment provided in a facility 44, and it performs charge and discharge of the battery 12c and the battery 12d mounted on the vehicle 10c and the vehicle 10d connected to the charge and discharge equipment 30c. If discharge of the battery 12c and the battery 12d is performed, power provided from the battery 12c and the battery 12d may be consumed by a power load within the facility 44, or may be provided to the power grid 90 through a power line disposed in the facility 44.

Each charge and discharge equipment 30 can charge the battery 12 with power received from the power grid 90. The charge and discharge equipment 30 can transmit power to the power grid 90 by discharging the battery 12.

When performing power transmission and reception between the power grid 90 and the battery 12, the charge and discharge equipment 30 and the control device 20 of the vehicle 10 perform charge and discharge of the battery 12 in accordance with a control of the control device 100. For example, if power shortage is occurring in the power grid 90, the control device 100 can perform power transmission from the battery 12 to the power grid 90 by instructing the charge and discharge equipment 30 and the control device 20 to discharge the battery 12. If there is an excess of power in the power grid 90, the control device 100 can reduce the excess of power of the power grid 90 by instructing the charge and discharge equipment 30 and the control device 20 to charge the battery. In this manner, the control device 100 can provide a primary adjusting force, a secondary adjusting force, a tertiary adjusting force, and the like in the power grid 90 in conjunction with the charge and discharge equipment 30 and the control device 20. Accordingly, the control device 100 can aggregate a plurality of the batteries 12 mounted on a plurality of the vehicles 10, and can provide a power resource for the power grid 90.

The aggregator server 180 is, for example, a server used by a power aggregator. The aggregator server 180 performs a power transaction in a power market. The control device 100 communicates with the aggregator server 180, and provides power of a required amount to the power grid 90. For example, the control device 100 controls the charge and discharge equipment 30 and the control device 20 to charge and discharge the battery 12 in accordance with a demand from the aggregator server 180, and provides power of an amount in accordance with the demand.

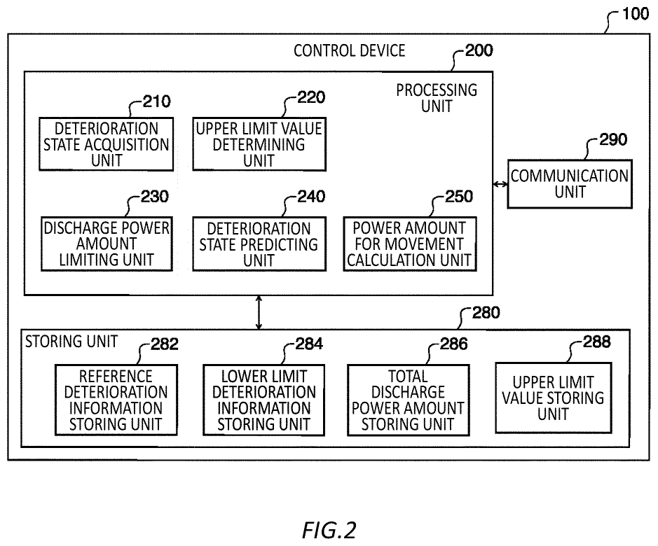

FIG. 2 illustrates an example of a system configuration of the control device 100. The control device 100 includes a processing unit 200, a storing unit 280, and a communication unit 290.

The processing unit 200 performs control of the communication unit 290. The communication unit 290 carries out communication between the aggregator server 180 and the vehicle 10. The processing unit 200 is achieved by an arithmetic processing device including a processor. The storing unit 280 is achieved by a non-volatile storage medium respectively included. The processing unit 200 performs processing by using information stored in the storing unit 280. The processing unit 200 may be achieved by a microcomputer including a CPU, a ROM, a RAM, an I/O, a bus, or the like. The control device 100 may be achieved by a computer.

In the present embodiment, the control device 100 is achieved by a single computer. However, in another embodiment, the control device 100 may be achieved by a plurality of computers. At least a part of functions of the control device 100 may be achieved by one or more servers such as a cloud server.

The processing unit 200 includes a deterioration state acquisition unit 210, an upper limit value determining unit 220, a discharge power amount limiting unit 230, a deterioration state predicting unit 240, and a power amount for movement calculation unit 250. The storing unit 280 includes a reference deterioration information storing unit 282, a lower limit deterioration information storing unit 284, a total discharge power amount storing unit 286, and an upper limit value storing unit 288.

The deterioration state acquisition unit 210 acquires a deterioration state of the battery 12 included in the vehicle 10. The upper limit value determining unit 220 determines, in accordance with the deterioration state acquired by the deterioration state acquisition unit 210, an upper limit value of a discharge power amount from the battery 12 to an outside of the vehicle 10 within a predetermined period. The discharge power amount limiting unit 230 limits the discharge power amount from the battery 12 to the outside of the vehicle 10 within the predetermined period to the upper limit value or lower.

The reference deterioration information storing unit 282 stores therein reference deterioration information representing a transition in reference values of the deterioration state of the battery 12 with respect to a use time of the vehicle 10. The upper limit value determining unit 220 determines the upper limit value based on a comparison between a reference value of the deterioration state decided from the reference deterioration information and the use time of the vehicle 10, and the deterioration state acquired by the deterioration state acquisition unit 210.

The upper limit value storing unit 288 stores therein a defined upper limit value. For example, the upper limit value storing unit 288 may store therein the upper limit value as an initial value. The upper limit value determining unit 220 may determine the upper limit value by correcting the defined upper limit value higher if the deterioration state acquired by the deterioration state acquisition unit 210 is higher than the reference value, and correcting the defined upper limit value lower if the deterioration state acquired by the deterioration state acquisition unit 210 is lower than the reference value.

The lower limit deterioration information storing unit 284 stores therein lower limit deterioration information representing a transition in lower limit values of the deterioration state of the battery 12 with respect to the use time of the vehicle 10. On the basis that the deterioration state shows lowness of deterioration of the battery 12, the discharge power amount limiting unit 230 prohibits discharge from the battery 12 to the outside of the vehicle 10 if the deterioration state acquired by the deterioration state acquisition unit 210 falls below a lower limit value of the deterioration state decided from the lower limit deterioration information and the use time of the vehicle 10.

The reference deterioration information storing unit 282 stores therein the reference deterioration information representing a transition in the reference values of the deterioration state of the battery 12 with respect to the use time of the vehicle 10. The deterioration state predicting unit 240 predicts the deterioration state of the battery 12 at a predetermined point of time in the future. The upper limit value determining unit 220 determines the upper limit value based on a comparison between the deterioration state predicted by the deterioration state predicting unit 240 and the reference value of the deterioration state decided from the reference deterioration information and the predetermined point of time.

The upper limit value determining unit 220 may determine the upper limit value by correcting the defined upper limit value higher if the deterioration state acquired by the deterioration state acquisition unit 210 is higher than the reference value, and correcting the defined upper limit value lower if the deterioration state acquired by the deterioration state acquisition unit 210 is lower than the reference value.

The total discharge power amount storing unit 286 stores therein a predetermined total discharge power amount that is allowed to be discharged from the battery 12 in a predetermined period. The power amount for movement calculation unit 250 calculates a total power amount of the battery 12 used for a movement of the vehicle 10. The upper limit value determining unit 220 determines the upper limit value by correcting, based on the deterioration state, a differential value in which a total discharge power amount to the outside and the total power amount calculated by the power amount for movement calculation unit 250 are subtracted from the total discharge power amount.

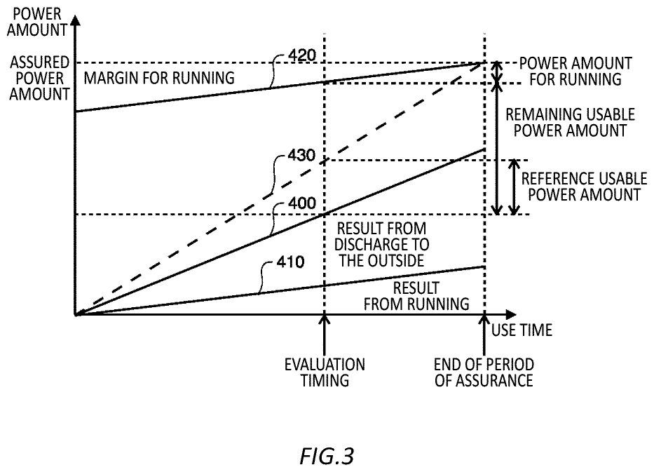

FIG. 3 is a drawing for describing parameters used for a power transmission and reception control between the outside of the vehicle 10 and the battery 12. The horizontal axis in the graph of FIG. 3 is times, and the vertical axis is power amounts. The origin point of the horizontal axis is, for example, at the time of shipment of the vehicle 10. The vertical axis represents discharge power amounts of the battery 12. In the present embodiment, the control device 100 controls charge and discharge of the battery 12 such that a power amount that is output by the battery 12 from a start of use of the vehicle 10 until a designated end of the period of use becomes a predetermined assured power amount or less. The assured power amount is a power amount that is practically assured to be output by the battery 12. The assured power amount may be stored in the total discharge power amount storing unit 286.

In FIG. 3, a line 400 shows the whole power amount output from the battery 12. A line 410 shows a power amount that is output from the battery 12 resulting from running of the vehicle 10 (result from running). A difference between the line 400 and the line 410 represents a power amount that is output from the battery 12 resulting from an operation other than running of the vehicle 10. In the present embodiment, the difference between the line 400 and the line 410 represents a power amount that is discharged from the battery 12 to the power grid 90 on the outside of the vehicle 10 (result from discharge to the outside).

A line 420 represents a power amount that should be secured for running of the vehicle 10 in the future, among the assured power amount that the battery 12 can output (a margin for running). A line 430 represents an assumed power amount when averagely using the battery 12 such that power of the assured power amount is output from the battery 12 from the start of use until the end of the period of use of the vehicle 10. That is, if the battery 12 is used along the line 430, the integral power amount that is output by the vehicle 10 from the start of use until the end of the period of use of the vehicle 10 will match the assured power amount. Reference information representing the line 430 is stored in the storing unit 280.

The power amount for movement calculation unit 250 calculates the power amount of the battery 12 at the end of the period of use, resulting from running of the vehicle 10. The power amount for movement calculation unit 250 may predict the power amount of the battery 12 at the end of the period of use resulting from running of the vehicle 10 by extrapolating, until the end of the period of use, a variation in the power amount that is output from the battery 12 resulting from running of the vehicle 10 from the start of use until the present of the vehicle 10. A value calculated by the power amount for movement calculation unit 250 is a total value of the power amount that is output from the battery 12 resulting from running of the vehicle 10 until the present and the power amount for running in FIG. 3.

The upper limit value determining unit 220 calculates a remaining usable power amount at the present evaluation timing. The upper limit value determining unit 220 calculates the remaining usable power amount by subtracting, from the assured power amount, the total value of the power amount calculated by the power amount for movement calculation unit 250 and the power amount that is output from the battery 12 to the power grid 90 until the present. The remaining usable power amount corresponds to the upper limit value that can be output from the battery 12 to the power grid 90 until the end of the period of use of the vehicle 10.

The discharge power amount limiting unit 230 calculates the reference usable power amount at the present evaluation timing. The discharge power amount limiting unit 230 calculates the reference power amount at the present by referring to the reference information. The reference power amount at the present is a value on the line 430 at the present. The discharge power amount limiting unit 230 calculates the reference usable power amount by subtracting, from the reference power amount, the power amount that is output from the battery 12 resulting from running of the vehicle 10 until the present and the power amount that is output from the battery 12 to the power grid 90 until the present. The discharge power amount limiting unit 230 limits charge and discharge of the battery 12 based on the remaining usable power amount and the reference usable power amount.

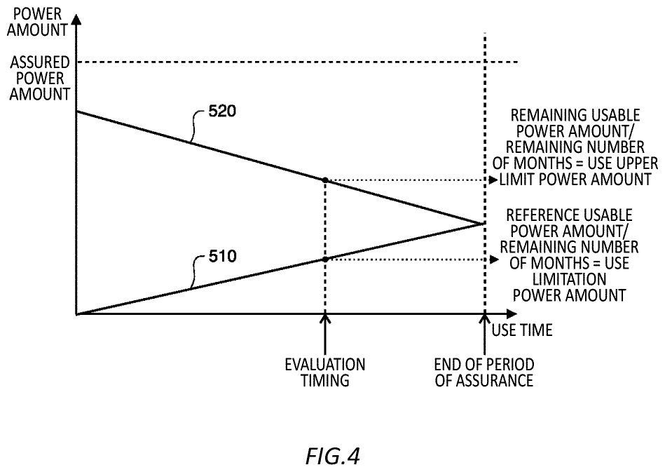

FIG. 4 conceptually illustrates variations in the remaining usable power amount and the reference usable power amount. In FIG. 4, a line 520 represents the remaining usable power amount, and a line 510 shows the reference usable power amount.

The discharge power amount limiting unit 230 calculates a use upper limit power amount by dividing the remaining usable power amount at the present by a remaining number of months until the end of the period of use. The use upper limit power amount corresponds to a power amount that is allowed to be output from the battery 12 to the power grid 90 per month. If the power amount that is output from the battery 12 to the power grid 90 per month exceeds the use upper limit power amount, it will exceed the assured power amount before the end of the period of use. Therefore, the discharge power amount limiting unit 230 controls charge and discharge of the battery 12 such that the power amount that is output from the battery 12 to the power grid 90 per month does not exceed the use upper limit power amount.

The discharge power amount limiting unit 230 calculates a use limitation power amount by dividing the reference usable power amount at the present by the remaining number of months until the end of the period of use. If the power amount that is output from the battery 12 to the power grid 90 per month exceeds the use limitation power amount, it will exceed the line 430 in FIG. 3. Therefore, the discharge power amount limiting unit 230 controls charge and discharge of the battery 12 such that the power amount that is output from the battery 12 to the power grid 90 per month does not exceed the use limitation power amount as much as possible.

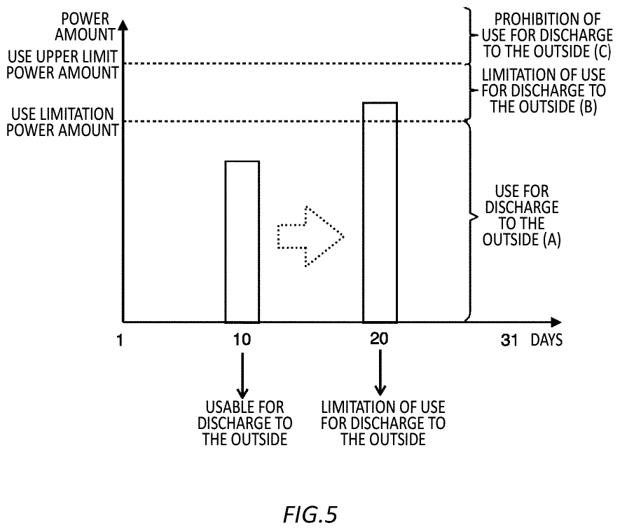

FIG. 5 is a drawing for describing a control of the discharge power amount limiting unit 230. The vertical axis in FIG. 5 is the power amount that is output to the power grid 90 within a month. The horizontal axis is the number of days in a month. The power amount that is output from the battery 12 to the power grid 90 from day 1 to day 10 is less than the use limitation power amount. Therefore, the discharge power amount limiting unit 230 judges that the battery 12 can be used for power discharge to the power grid 90 (use for discharge to the outside).

On the other hand, the power amount that is output from the battery 12 to the power grid 90 from day 1 to day 20 exceeds the use limitation power amount. Therefore, the discharge power amount limiting unit 230 limits the use of the battery 12 for power discharge to the power grid 90 (limitation of use for discharge to the outside). For example, the discharge power amount limiting unit 230 uses the battery 12 for power discharge to the power grid 90 on the condition that the power amount that is required to be discharged to the power grid 90 cannot be discharged from another battery 12 that is judged to be “use for discharge to the outside”. If the power amount that is required to be discharged to the power grid 90 can be discharged from another battery 12 judged to be “use for discharge to the outside”, the discharge power amount limiting unit 230 does not use the battery 12 for power discharge to the power grid 90.

It should be noted that, if the power amount that is output from the battery 12 to the power grid 90 exceeds the use upper limit power amount, the discharge power amount limiting unit 230 prohibits use of the battery 12 for power discharge to the power grid 90 (prohibition of use for discharge to the outside). In addition, in FIG. 5, A shows that the battery 12 can be preferentially selected for power discharge to the power grid 90. B shows that the battery 12 can be limitedly selected for power discharge to the power grid 90. C shows that the battery 12 cannot be selected for power discharge to the power grid 90. In this manner, A, B, and C show priorities of using the battery 12 for power discharge to the power grid 90. Specifically, A shows that the priority is higher than B, and B shows that the priority is lower than C.

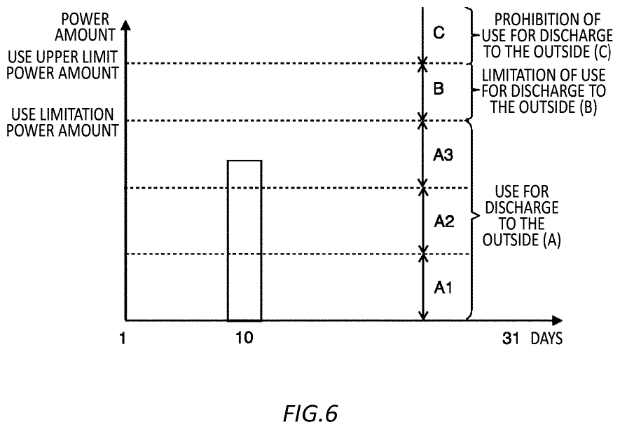

FIG. 6 illustrates an example of dividing a range of A, which is usable for discharge to the outside, into three priorities. The vertical axis in FIG. 6 is the power amount that is output to the power grid 90 within a month, and the horizontal axis is the number of days in a month, as in the case of FIG. 5. FIG. 6 shows the power amount that is output from the battery 12 to the power grid 90 from day 1 to day 10.

In FIG. 6, the range of A is divided into three ranges corresponding to A1, A2, and A3. A1, A2, and A3 show priorities of using the battery 12 for power discharge to the power grid 90. A1 shows that the priority is higher than A2, and A2 shows that the priority is higher than A3. The power amount that is output from the battery 12 to the power grid 90 from day 1 to day 10 is within the range corresponding to A3. Thus, the discharge power amount limiting unit 230 sets the priority of using the battery 12 for power discharge to the power grid 90 to A3.

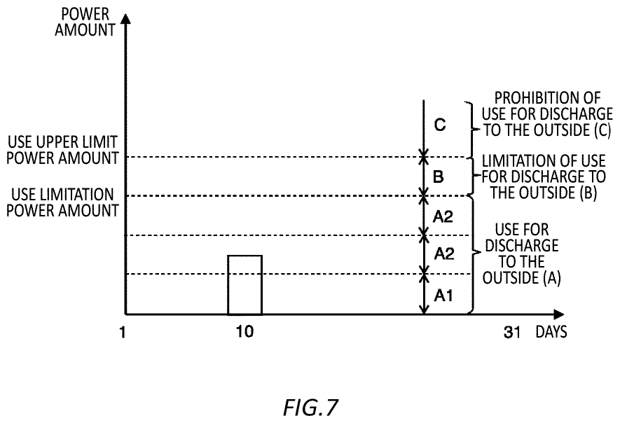

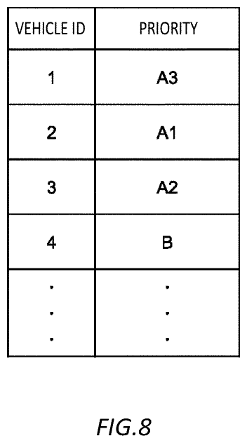

FIG. 7 illustrates a priority in another battery 12. FIG. 7 is a drawing similar to FIG. 6, and it illustrates the power amount that is output from the another battery 12 to the power grid 90 from day 1 to day 10. As illustrated in FIG. 8, the power amount that is output from the another battery 12 to the power grid 90 from day 1 to day 10 is within the range corresponding to A2. Thus, the discharge power amount limiting unit 230 sets the priority of using the another battery 12 for power discharge to the power grid 90 to A2.

FIG. 8 illustrates a priority that is set for the battery 12 of each vehicle 10. The discharge power amount limiting unit 230 selects the battery 12 of the vehicle 10 for which the priority of A1, A2, or A3 is set, as the battery to be used for discharging power to the power grid 90, in the order of A1, A2, and A3. If the total value of the power amount that can be provided from the battery 12 for which the priority of A1, A2, or A3 is set is less than the power amount that is required to be discharged to the power grid 90, the discharge power amount limiting unit 230 selects the battery 12 of the vehicle 10 for which the priority of B is set, as the battery to be used for discharging power to the power grid 90.

Accordingly, discharge of power from the battery 12 to the power grid 90 can be controlled such that the battery 12 does not become too deteriorated in the future within the period of assurance, and thus it is possible to avoid interference to running of the vehicle 10 in the future. In addition, the battery 12 of the vehicle 10 that is not used for running that much can be preferentially used for power discharge to the power grid 90. Therefore, for users of the vehicle 10, opportunities to obtain an incentive that is given to the use of the battery 12 for power discharge to the power grid 90 will be increased.

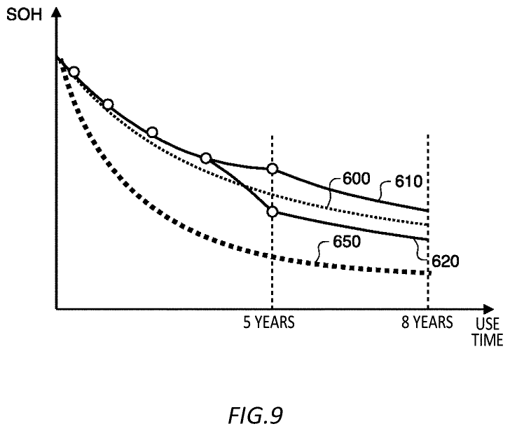

FIG. 9 is a graph illustrating an example of a transition in the deterioration states of the battery 12. The horizontal axis of the graph in FIG. 9 is the use time of the vehicle 10, and the vertical axis is the SOH (State of health).

The SOH is an example of the deterioration state of the battery 12. The SOH is also referred to as the state of health. The SOH may be represented by a capacity maintenance rate or an increase rate of internal resistance. In the present embodiment, the SOH is represented by, for example, the capacity maintenance rate, and it shows lowness of deterioration of the battery 12. The use time is, for example, an elapsed time from the start of use of the vehicle 10. Due to the use of the battery 12 in accordance with the use of the vehicle 10, the SOH of the battery 12 may be lowered.

A reference line 600 shows a transition in reference values of the SOH that varies with respect to a passage of the use time of the vehicle 10. The reference deterioration information representing the reference line 600 is stored in the reference deterioration information storing unit 282. The reference deterioration information may be a conversion table for converting a use time into a deterioration threshold value.

A lower limit line 650 shows a SOH lower limit value that varies depending on the use time of the vehicle 10. The SOH lower limit value is the lowest value allowed for lowering in the SOH of the battery 12. The reference line 600 is set higher than the lower limit line 650. The lower limit deterioration information representing the lower limit line 650 is stored in the lower limit deterioration information storing unit 284. The lower limit deterioration information may be a conversion table for converting a use time into a deterioration threshold value.

A line 610 is an example of a transition in the SOH when a state that the SOH of the battery 12 exceeds the reference line 600 is continued. In this case, the upper limit value determining unit 220 corrects the remaining usable power amount or the assured power amount higher. For example, the upper limit value determining unit 220 determines the assured power amount by correcting the defined upper limit value of the assured power amount stored in the upper limit value storing unit 288 higher. Accordingly, at least either of the use upper limit power amount and the use limitation power amount is calculated higher. Accordingly, for example, at least either of the use upper limit power amount and the use limitation power amount illustrated in FIG. 5 will be shifted higher. As a result, an opportunity of the discharge power amount limiting unit 230 judging that the battery 12 can be used for power discharge to the power grid 90 will increase. Accordingly, it is possible to prevent the SOH from being remarkably higher with respect to the reference line 600. Therefore, the battery 12 can be sufficiently used for power transmission and reception between the power grid 90 until the end of the period of use.

A line 620 is an example of a transition of the SOH when a state that the SOH of the battery 12 falls below the reference line 600 is continued, in a period where the use time is at least the fifth or subsequent years. In this case, the upper limit value determining unit 220 corrects the remaining usable power amount or the assured power amount lower. For example, the upper limit value determining unit 220 determines the assured power amount by correcting the defined upper limit value of the assured power amount stored in the upper limit value storing unit 288 lower. Accordingly, at least either of the use upper limit power amount and the use limitation power amount is calculated lower. Accordingly, for example, at least either of the use upper limit power amount and the use limitation power amount illustrated in FIG. 5 will be shifted lower. As a result, an opportunity of the discharge power amount limiting unit 230 judging that the battery 12 can be used for power discharge to the power grid 90 will decrease. Accordingly, it is possible to prevent the SOH from being remarkably lower with respect to the reference line 600. Therefore, it is possible to prevent the battery 12 from being remarkably deteriorated before the end of the period of use.

It should be noted that the discharge power amount limiting unit 230 does not select the battery 12 in which the SOH is the lower limit line 650 or lower as the battery 12 for performing power transmission and reception between the power grid 90. In this manner, if the SOH falls below the lower limit value of the SOH decided from the lower limit deterioration information and the use time, the discharge power amount limiting unit 230 prohibits discharge from the battery 12 to the power grid 90.

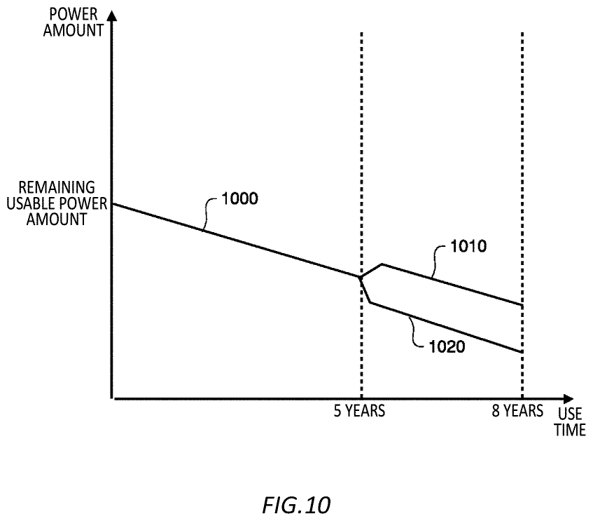

FIG. 10 illustrates an example of a transition in remaining usable power amounts. A line 1000 shows a transition in the remaining usable power amounts by the use time up to the fifth year. A line 1010 shows a state that the remaining usable power amount is corrected higher in the fifth or subsequent years. A line 1020 shows a state that the remaining usable power amount is corrected lower in the fifth or subsequent years.

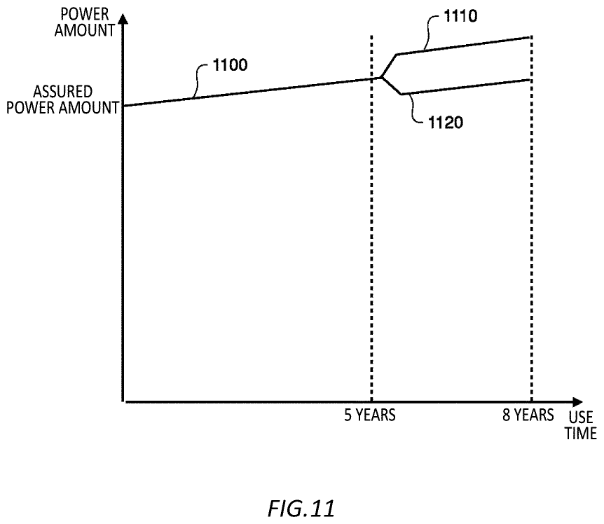

FIG. 11 illustrates an example of a transition in assured power amounts. A line 1100 shows a transition in the assured power amounts by the use time up to the fifth year. A line 1110 shows a state that the assured power amount is corrected higher in the fifth or subsequent years. A line 1120 shows a state that the assured power amount is corrected lower in the fifth or subsequent years.

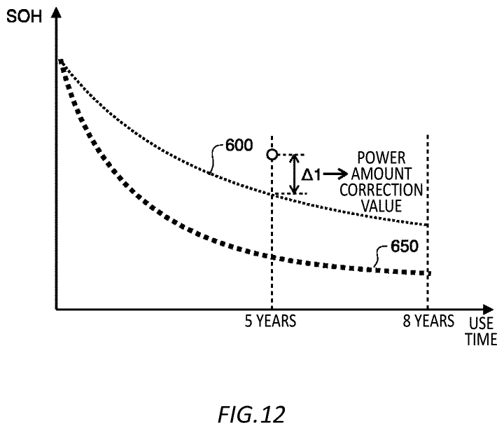

FIG. 12 illustrates that, based on the present SOH, a correction value of the assured power amount or the remaining usable power amount is calculated. Δ1 shows a difference between the SOH of the battery 12 in the fifth year and the reference SOH decided from the reference line 600 and the use time (5 years). The upper limit value determining unit 220 calculates, based on the difference Δ1 of the SOH, the correction value of the assured power amount or the remaining usable power amount. For example, the upper limit value determining unit 220 may calculate the correction value of the assured power amount or the remaining usable power amount by using a predetermined conversion map for converting Δ1 into a correction value of the assured power amount or the remaining usable power amount.

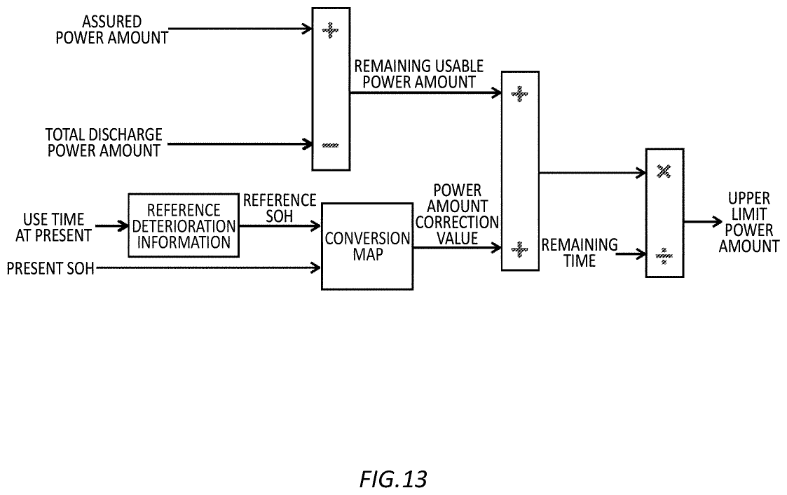

FIG. 13 illustrates an operation content of the control device 100 when correcting the remaining usable power amount based on the present SOH.

First, the remaining usable power amount is calculated by subtracting the total discharge power amount from the assured power amount. The total discharge power amount is, for example, the total value of the power amount discharged from the battery 12 when the vehicle 10 is running, and a power amount discharged to the outside. The total discharge power amount may be calculated in consideration of the above-mentioned margin for running.

The reference SOH is calculated based on the use time of the vehicle 10 up to the present and the reference deterioration information. The reference SOH is a value of the SOH on the reference line 600 at the present. Subsequently, a power amount correction value is calculated by using the reference SOH, the SOH at the present, and the conversion map. The conversion map may be map information having the reference SOH and the SOH at the present as inputs, and the power amount correction value as an output. The conversion map may output a larger power amount correction value as the difference between the SOH at the present and the reference SOH becomes larger.

Subsequently, the remaining usable power amount is corrected by adding the power amount correction value to the remaining usable power amount. Subsequently, the upper limit power amount per unit time is calculated by dividing the corrected remaining usable power amount by a remaining time until the end of the period of use. In the example that is described in relation to FIG. 4 and the like, the remaining number of months until the end of the period of use is used as the remaining time until the end of the period of use. In this case, the use upper limit power amount per month when using the battery 12 for power transmission and reception between the power grid 90 is calculated.

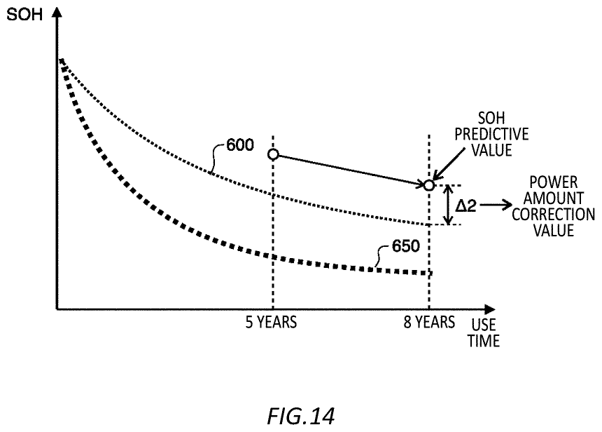

FIG. 14 illustrates that, based on a SOH predictive value at the end of the period of use, a correction value of the assured power amount or the remaining usable power amount is calculated. The deterioration state predicting unit 240 predicts the SOH at the end of the period of use (for example, 8 years) from the SOH of the battery 12 in the fifth year. For example, the deterioration state predicting unit 240 may calculate the SOH predictive value in the future by using future prediction information of the SOH that is generated based on history information of the SOH collected from many vehicles 10.

Δ2 shows a difference between the reference SOH decided from the use time at the end of the period of use (8 years) and the reference line 600, and the SOH predictive value. The upper limit value determining unit 220 calculates, based on the difference Δ2 of the SOH, the correction value of the assured power amount or the remaining usable power amount. For example, the upper limit value determining unit 220 may calculate the correction value of the assured power amount or the remaining usable power amount by referring to the predetermined conversion map for converting Δ2 into a correction value of the assured power amount or the remaining usable power amount.

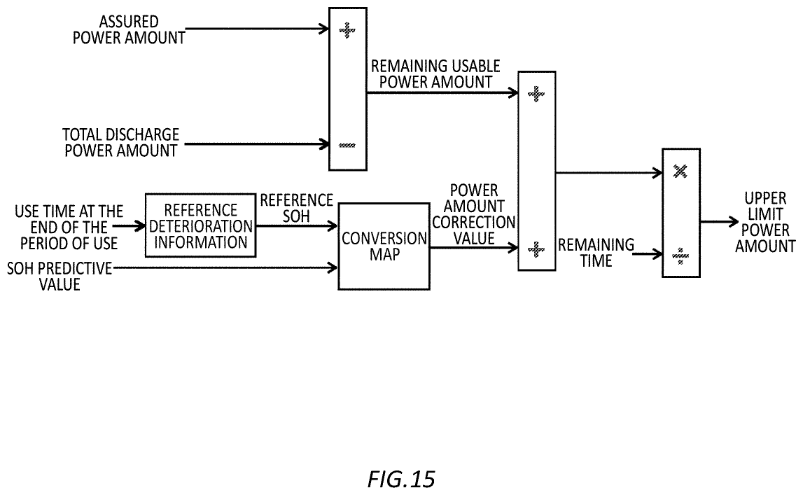

FIG. 15 illustrates the operation content of the control device 100 when correcting, based on the SOH at the end of the period of use, the remaining usable power amount.

First, the remaining usable power amount is calculated by subtracting the total discharge power amount from the assured power amount. The total discharge power amount is, for example, the total value of the power amount discharged from the battery 12 when the vehicle 10 is running, and the power amount discharged to the outside. The total discharge power amount may be calculated in consideration of the above-mentioned margin for running.

In addition, the reference SOH is calculated based on the use time of the vehicle 10 at the end of the period of use and the reference deterioration information. The reference SOH is a value of the SOH on the reference line 600 at the end of the period of use. Subsequently, the power amount correction value is calculated by using the reference SOH, the SOH predictive value, and the conversion map. The conversion map may be map information having the reference SOH and the SOH predictive value as inputs, and the power amount correction value as an output. The conversion map may output a larger power amount correction value as the difference between the SOH predictive value and the reference SOH becomes larger.

Subsequently, the remaining usable power amount is corrected by adding the power amount correction value to the remaining usable power amount. Subsequently, the upper limit power amount per unit time is calculated by dividing the corrected remaining usable power amount by the remaining time until the end of the period of use. In the example that is described in relation to FIG. 4 and the like, the remaining number of months until the end of the period of use is used as the remaining time until the end of the period of use. In this case, the use upper limit power amount per month when using the battery 12 for power transmission and reception between the power grid 90 is calculated.

According to the control device 100 described above, it is possible to determine the upper limit value of a power amount that is allowed to be received and passed between the power grid 90 until the end of the period of use in accordance with the deterioration state of the battery 12. Therefore, it is possible to prevent the battery 12 from being too deteriorated at the end of the period of use. In addition, opportunities of providing adjustment power to the power grid 90 by using the battery 12 until the end of the period of use can be sufficiently increased. Therefore, for users of the vehicle 10, opportunities to obtain an incentive that is given to the use of the battery 12 for power discharge to the power grid 90 will be increased. In addition, a remaining life of the battery 12 can be averaged among a plurality of the vehicles 10.

In the present embodiment, the control device 100 is provided on the outside of the vehicle 10, and it controls the vehicle 10 through the communication network 190. However, a form that at least a part of functions of the control device 100 is provided for the control device 20 of the vehicle 10 may be applied.

The vehicle 10 may be electric-powered vehicles including an electric vehicle, a hybrid automobile, and a saddle-type vehicle such as an electric-powered motorcycle. The vehicle 10 is an example of the moving object. The moving object may be any moving object including a battery that moves on land other than vehicles. The moving object may include an aircraft such as an unmanned aerial vehicle (UAV), a marine vessel, and the like.

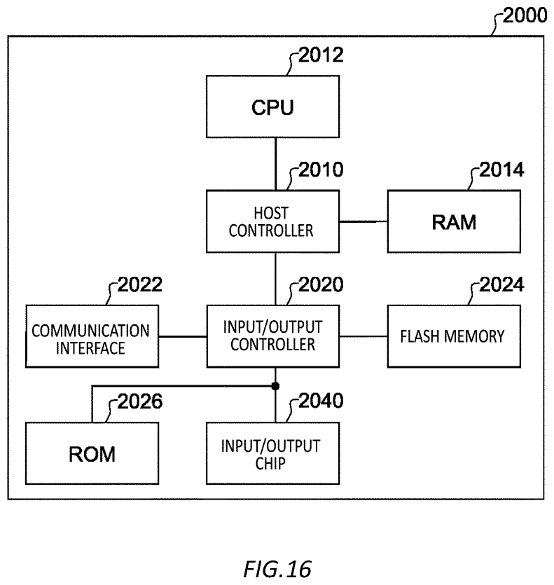

FIG. 16 illustrates an example of a computer 2000 in which a plurality of embodiments of the present invention may be entirely or partially embodied. A program installed in the computer 2000 can cause the computer 2000 to function as a system according to an embodiment or each unit of the system, or the control device 100 or a device such as the control device 100 or each unit of the device, execute an operation associated with the system or each unit of the system, or the device or each unit of the device, and/or execute a process according to the embodiment or a step of the process. Such a program may be executed by a CPU 2012 to cause the computer 2000 to perform certain operations associated with the processing procedures described herein and some of or all of the blocks in the block diagrams.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, thereby controlling each unit.

The communication interface 2022 communicates with other electronic devices via a network. The flash memory 2024 stores programs and data used by the CPU 2012 within the computer 2000. The ROM 2026 stores therein a boot program or the like executed by the computer 2000 at the time of activation, and/or a program depending on the hardware of the computer 2000. The input/output chip 2040 may connect various input/output units such as a keyboard, a mouse, and a monitor to the input/output controller 2020 via input/output ports such as a serial port, a parallel port, a keyboard port, a mouse port, a monitor port, a USB port, and a HDMI (registered trademark) port.

A program is provided via a network or computer-readable storage media such as a CD-ROM, a DVD-ROM, or a memory card. The RAM 2014, the ROM 2026, or the flash memory 2024 is an example of the computer-readable storage medium. Programs are installed in the flash memory 2024, the RAM 2014, or the ROM 2026 and executed by the CPU 2012. The information processing written in these programs is read by the computer 2000, and thereby cooperation between a program and the above-described various types of hardware resources is achieved. A device or method may be constituted by carrying out the operation or processing of information by using the computer 2000.

For example, when communication is carried out between the computer 2000 and an external device, the CPU 2012 may execute a communication program loaded onto the RAM 2014 to instruct communication processing to the communication interface 2022, based on the processing written in the communication program. The communication interface 2022, under control of the CPU 2012, reads transmission data stored on transmission buffering regions provided in recording media such as the RAM 2014 and the flash memory 2024, and transmits the read transmission data to a network and writes reception data received from a network to reception buffering regions or the like provided on the recording media.

In addition, the CPU 2012 may cause all or a necessary portion of a file or a database to be read into the RAM 2014, the file or the database having been stored in a recording medium such as the flash memory 2024, etc., and perform various types of processing on the data on the RAM 2014. The CPU 2012 may then write back the processed data to the recording medium.

Various types of information, such as various types of programs, data, tables, and databases, may be stored in the recording medium to undergo information processing. The CPU 2012 may perform various types of processing on the data read from the RAM 2014, which includes various types of operations, information processing, conditional judging, conditional branch, unconditional branch, search/replacement of information, etc., as described herein and designated by an instruction sequence of programs, and writes the result back to the RAM 2014. In addition, the CPU 2012 may search for information in a file, a database, etc., in the recording medium. For example, when a plurality of entries, each having an attribute value of a first attribute associated with an attribute value of a second attribute, are stored in the recording medium, the CPU 2012 may search for an entry matching the condition whose attribute value of the first attribute is designated, from among the plurality of entries, and read the attribute value of the second attribute stored in the entry, thereby acquiring the attribute value of the second attribute associated with the first attribute satisfying the predetermined condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet can be used as the computer-readable storage media. A program stored in the computer-readable storage medium may be provided to the computer 2000 via a network.

The program installed in the computer 2000 and causing the computer 2000 to function as the control device 100 may instruct the CPU 2012 or the like to cause the computer 2000 to respectively function as each unit of the control device 100. Information processing written in these programs is read in the computer 2000 to function as each unit of the control device 100, which is a specific means in which a software and various hardware resources described above are in cooperation. Then, these specific means implement operations or processing of information in accordance with the intended use of the computer 2000 in the present embodiment, so that the control device 100 is constructed as a specific device in accordance with the intended use.

The program installed in the computer 2000 and causing the computer 2000 to function as the control device 20 may instruct the CPU 2012 or the like to cause the computer 2000 to respectively function as each unit of the control device 20. Information processing written in these programs is read in the computer 2000 to function as each unit of the control device 20, which is a specific means in which a software and various hardware resources described above are in cooperation. Then, these specific means implement operations or processing of information in accordance with the intended use of the computer 2000 in the present embodiment, so that the control device 20 is constructed as a specific device in accordance with the intended use.

Various embodiments have been described by referring to the block diagrams and the like. In the block diagram, each block may represent (1) a step of a process in which an operation is executed, or (2) each unit of the device having a role of executing the operation. Certain steps and each unit may be implemented by dedicated circuits, programmable circuits supplied with computer-readable instructions stored on computer-readable storage media, and/or processors supplied with computer-readable instructions stored on computer-readable storage media. Dedicated circuits may include digital and/or analog hardware circuits and may include integrated circuits (IC) and/or discrete circuits. Programmable circuits may include reconfigurable hardware circuits including logical AND, logical OR, logical XOR, logical NAND, logical NOR, and other logical operations, flip-flops, registers, memory elements, etc., such as field-programmable gate arrays (FPGA), programmable logic arrays (PLA), etc.

Computer-readable storage media may include any tangible device that can store instructions for execution by a suitable device, such that the computer-readable storage medium having instructions stored therein forms at least a part of an article of manufacture including instructions which can be executed to create means for performing processing procedure or operations specified in the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disk (DVD), a Blu-ray (registered trademark) disk, a memory stick, an integrated circuit card, or the like.

The computer-readable instruction may include an assembler instruction, an instruction-set-architecture (ISA) instruction, a machine instruction, a machine dependent instruction, a microcode, a firmware instruction, state-setting data, or either of source code or object code written in any combination of one or more programming languages including an object-oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, special purpose computer, or other programmable data processing device, or to programmable circuit, locally or via a local area network (LAN), wide area network (WAN) such as the Internet, etc., to execute the computer-readable instructions to provide means for performing described processing procedure or operations specified in the block diagrams. Examples of the processor include a computer processor, a processing unit, a microprocessor, a digital signal processor, a controller, a microcontroller, and the like.

While the present invention has been described with the embodiments, the technical scope of the present invention is not limited to the above-described embodiments. It is apparent to persons skilled in the art that various alterations or improvements can be added to the above-described embodiments. It is also apparent from the description of the claims that the embodiments to which such alterations or improvements are made can be included in the technical scope of the present invention.

The operations, procedures, steps, stages, and the like of each process performed by a device, system, program, and method shown in the claims, specification, or drawings can be performed in any order as long as the order is not indicated by “prior to,” “before,” or the like and as long as the output from a previous process is not used in a later process. Even if the operation flow is described using phrases such as “first” or “next” in the claims, specification, or drawings, it does not necessarily mean that the process must be performed in this order.

### EXPLANATION OF REFERENCES

5: system; 10: vehicle; 12: battery; 20: control device; 30: charge and discharge equipment; 42: dwelling unit; 44: facility; 70: power consumer; 80: power generating device; 90: power grid; 100: control device; 180: aggregator server; 190: communication network; 200: processing unit; 210: deterioration state acquisition unit; 220: upper limit value determining unit; 230: discharge power amount limiting unit; 240: deterioration state predicting unit; 250: power amount for movement calculation unit; 280: storing unit; 282: reference deterioration information storing unit; 284: lower limit deterioration information storing unit; 286: total discharge power amount storing unit; 288: upper limit value storing unit; 290: communication unit; 2000: computer; 2010: host controller; 2012: CPU; 2014: RAM; 2020: input/output controller; 2022: communication interface; 2024: flash memory; 2026: ROM; 2040: input/output chip.

What is claimed is:

1. A control device, comprising:
a deterioration state acquisition unit for acquiring a deterioration state of a battery provided for a moving object;
an upper limit value determining unit for determining, in accordance with the deterioration state acquired by the deterioration state acquisition unit, an upper limit value of a discharge power amount from the battery to an outside of the moving object within a predetermined period; and
a discharge power amount limiting unit for limiting the discharge power amount from the battery to the outside of the moving object within the predetermined period, to the upper limit value or lower.

2. The control device according to claim 1, further comprising a reference deterioration information storing unit for storing therein reference deterioration information representing a transition in reference values of the deterioration state of the battery with respect to a use time of the moving object, wherein
the upper limit value determining unit determines the upper limit value based on a comparison between a reference value of the deterioration state decided from the reference deterioration information and the use time of the moving object, and the deterioration state acquired by the deterioration state acquisition unit.

3. The control device according to claim 2, further comprising an upper limit value storing unit for storing therein a defined upper limit value, wherein
the upper limit value determining unit determines the upper limit value by correcting the defined upper limit value higher if the deterioration state acquired by the deterioration state acquisition unit is higher than the reference value, and correcting the defined upper limit value lower if the deterioration state acquired by the deterioration state acquisition unit is lower than the reference value.

4. The control device according to claim 1, further comprising a lower limit deterioration information storing unit for storing therein lower limit deterioration information representing a transition in lower limit values of a deterioration state of the battery with respect to a use time of the moving object, wherein
the deterioration state shows lowness of deterioration of the battery, and
the discharge power amount limiting unit prohibits discharge from the battery to the outside of the moving object if the deterioration state acquired by the deterioration state acquisition unit falls below a lower limit value of the deterioration state decided from the lower limit deterioration information and the use time of the moving object.

5. The control device according to claim 1, further comprising:
a reference deterioration information storing unit for storing therein reference deterioration information representing a transition in reference values of the deterioration state of the battery with respect to a use time of the moving object; and
a deterioration state predicting unit for predicting a deterioration state of the battery at a predetermined point of time in a future,
wherein the upper limit value determining unit determines the upper limit value based on a comparison between the deterioration state predicted by the deterioration state predicting unit and a reference value of the deterioration state decided from the reference deterioration information and the predetermined point of time.

6. The control device according to claim 5, further comprising an upper limit value storing unit for storing therein a defined upper limit value, wherein
the upper limit value determining unit determines the upper limit value by correcting the defined upper limit value higher if the deterioration state acquired by the deterioration state acquisition unit is higher than the reference value, and correcting the defined upper limit value lower if the deterioration state acquired by the deterioration state acquisition unit is lower than the reference value.

7. The control device according to claim 1, further comprising:
a total discharge power amount storing unit for storing therein a predetermined total discharge power amount that is allowed to be discharged from the battery within the predetermined period; and
a power amount for movement calculation unit for calculating a total power amount of the battery that is used for a movement of the moving object,
wherein the upper limit value determining unit determines the upper limit value by correcting, based on the deterioration state, a differential value in which a total discharge power amount to the outside and the total power amount calculated by the power amount for movement calculation unit are subtracted from the total discharge power amount.

8. The control device according to claim 2, further comprising a lower limit deterioration information storing unit for storing therein lower limit deterioration information representing a transition in lower limit values of the deterioration state of the battery with respect to the use time of the moving object, wherein
the deterioration state shows lowness of deterioration of the battery, and
the discharge power amount limiting unit prohibits discharge from the battery to the outside of the moving object if the deterioration state acquired by the deterioration state acquisition unit falls below a lower limit value of the deterioration state decided from the lower limit deterioration information and the use time of the moving object.

9. The control device according to claim 3, further comprising a lower limit deterioration information storing unit for storing therein lower limit deterioration information representing a transition in lower limit values of the deterioration state of the battery with respect to the use time of the moving object, wherein
the deterioration state shows lowness of deterioration of the battery, and
the discharge power amount limiting unit prohibits discharge from the battery to the outside of the moving object if the deterioration state acquired by the deterioration state acquisition unit falls below a lower limit value of the deterioration state decided from the lower limit deterioration information and the use time of the moving object.

10. The control device according to claim 2, further comprising:
a reference deterioration information storing unit for storing therein reference deterioration information representing a transition in reference values of the deterioration state of the battery with respect to the use time of the moving object; and
a deterioration state predicting unit for predicting the deterioration state of the battery at a predetermined point of time in a future,
wherein the upper limit value determining unit determines the upper limit value based on a comparison between the deterioration state predicted by the deterioration state predicting unit and a reference value of the deterioration state decided from the reference deterioration information and the predetermined point of time.

11. The control device according to claim 10, further comprising an upper limit value storing unit for storing therein a defined upper limit value, wherein
the upper limit value determining unit determines the upper limit value by correcting the defined upper limit value higher if the deterioration state acquired by the deterioration state acquisition unit is higher than the reference value, and correcting the defined upper limit value lower if the deterioration state acquired by the deterioration state acquisition unit is lower than the reference value.

12. The control device according to claim 2, further comprising:
a total discharge power amount storing unit for storing therein a predetermined total discharge power amount allowed to be discharged from the battery within the predetermined period; and
a power amount for movement calculation unit for calculating a total power amount of the battery used for a movement of the moving object,
wherein the upper limit value determining unit determines the upper limit value by correcting, based on the deterioration state, a differential value in which a total discharge power amount to the outside and the total power amount calculated by the power amount for movement calculation unit are subtracted from the total discharge power amount.

13. The control device according to claim 1, wherein the moving object is a vehicle.

14. A moving object comprising the control device according to claim 1.

15. A method, comprising:
acquiring a deterioration state of a battery provided for a moving object;
determining, in accordance with the deterioration state, an upper limit value of a discharge power amount from the battery to an outside of the moving object within a predetermined period; and
limiting the discharge power amount from the battery to the outside of the moving object within the predetermined period to the upper limit value or lower.

16. A non-transitory computer-readable storage medium having stored therein a program for causing a computer to function as:
a deterioration state acquisition unit for acquiring a deterioration state of a battery provided for a moving object;
an upper limit value determining unit for determining, in accordance with the deterioration state acquired by the deterioration state acquisition unit, an upper limit value of a discharge power amount from the battery to an outside of the moving object within a predetermined period; and
a discharge power amount limiting unit for limiting the discharge power amount from the battery to the outside of the moving object within the predetermined period to the upper limit value or lower.
